(19) United States
(12) Patent Application Publication
(10) Pub. No.: US 2010/0170598 A1
(43) Pub. Date: Jul. 8, 2010

(54) Tire structure with inked rubber skin and method of manufacturing the same

(76) Inventor: Hsi-Ming Hsieh, Changhua City (TW)

Correspondence Address: CHARLES E. BAXLEY, ESQUIRE, 90 JOHN STREET, SUITE 309, NEW YORK, NY, 10038, US

(21) Appl. No.: 12/383,011

(22) Filed: Mar. 19, 2009

(30) Foreign Application Priority Data
Jan. 5, 2009 (TW) 098100018

(51) Int. Cl. B60C 11/00; B29B 15/00

(52) U.S. Cl. 152/209.1; 156/116

(57) ABSTRACT

A tire structure includes a green base tire and a green inked rubber skin combined with a surface of one of tire walls of the green base tire, combined with a tire surface, or combined with the tire surface and the tire wall to have a ring structure. Thus, decorative patterns and texts can be printed on the green inked rubber skin so that the tire has the higher visibility. Also, a manufacturing method is also disclosed. The method includes the steps of: providing a green base tire and a green inked rubber skin; temporarily adhering the green inked rubber skin to a predetermined position of the green base tire to form an assembly; and then placing the assembly into a vulcanizing machine for heating and vulcanizing for a period of time so that the green inked rubber skin can be permanently combined with the green base tire.

### BACKGROUND OF THE INVENTION

1. Field of the Invention

The invention relates in general to a tire structure and a method of manufacturing the same, and more particularly to a tire applied to a bicycle, a motorcycle or a vehicle.

2. Description of the Related Art

The key points of designing a typical tire reside in the shapes and the arrangement of wearing projections on a tire surface. Thus, the tire usually cannot catch the consumer's eye.

U.S. Pat. No. 7,118,643 discloses a method of manufacturing a tire with an exo-belt skin. In this method, a partially cured base tire and a partially cured skin are temporarily combined in advance to form an assembly. Than, the assembly is placed in a vulcanizing machine for heating and vulcanizing so that the base tire and the skin are combined together.

Each of the partially cured base tire and the partially cured skin has the low adhesive property and the high rigidity, so they cannot be easily combined together. Although the vulcanizing machine can combine the base tire with the skin and shape the base tire and the skin, the operations of adhering the partially cured base tire to the skin and placing the partially cured base tire and the skin into a mold before heating and vulcanizing may become inconvenient and also higher cost due to the partial cured processes for the tire and skin are required.

### SUMMARY OF THE INVENTION

A main object of the invention is to provide a tire structure with an inked rubber skin, wherein the tire structure has the obvious visual effect so that the visibility can be enhanced.

Another object of the invention is to provide a method of manufacturing the tire structure with the inked rubber skin, in which a green inked rubber skin and a green base tire are conveniently combined together and can be easily placed into a mold for heating and vulcanizing to ensure the higher quality of tire as well as to reduce the cost of the process.

The invention achieves the above-identified objects by providing a tire structure including a green base tire and a green inked rubber skin. The green base tire has two opposite tire lips, two tire walls respectively extending from sides of the two tire lips, and a tire surface located between the two opposite tire walls. The green inked rubber skin is combined with a surface of one of the tire walls of the green base tire to form a ring structure, combined with the tire surface, or combined with the tire surface and the tire walls. Thus, the tire has the higher visibility according to decorative patterns and texts printed on the green inked rubber skin.

In addition, the method of manufacturing the tire structure of the invention includes the steps of: providing a green base tire and a green inked rubber skin; temporarily adhering the green inked rubber skin to a predetermined position of the green base tire to form an assembly; and then placing the assembly into a vulcanizing machine for heating and vulcanizing for a period of time so that the green inked rubber skin is permanently combined with the green base tire. Because the green base tire and the green inked rubber skin have the higher adhesive properties, the lower rigidity and the shapes that can easily be processed, and the green base tire and the green inked rubber skin may be easily combined together, the operations of adhering and placing the assembly into a mold become simpler.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is a partially exterior illustration showing a first embodiment of the invention;

FIG. 2 is a partially exterior illustration showing a second embodiment of the invention;

FIG. 3 is a partially exterior illustration showing a third embodiment of the invention;

FIG. 4 shows a fourth embodiment of the invention;

FIG. 5 is a partially exterior illustration showing a fifth embodiment of the invention;

FIG. 6 is a partially exterior illustration showing a sixth embodiment of the invention;

FIGS. 7A and 7B are schematic illustrations showing used states in this invention;

FIGS. 8A and 8B are schematic illustrations showing other used states in this invention;

FIGS. 9A and 9B are schematic illustrations showing other used states in this invention; and

FIG. 10 is a block diagram showing steps of a manufacturing method according to the invention.

### DETAILED DESCRIPTION OF THE INVENTION

FIG. 1 is a partially exterior illustration showing a first embodiment of the invention. As shown in FIG. 1, a tire structure of the invention is composed of a green base tire (or green tire) 10 and a green inked rubber skin 20 combined with a surface of the green base tire 10 to form a ring structure.

More specifically, the green base tire 10 has two opposite tire lips 12, and two tire walls 14 respectively extending from sides of the two tire lips 12. A tire surface 16 is located between the two opposite tire walls 14.

The tire surface 16 is a portion or a region contacting with the ground. The tire lip 12 is a portion to be embedded into a wheel rim (not shown). The tire wall 14 usually serves as a region where dimensions, specifications or other marked texts or patterns of the tire are printed.

The tire surface 16 of the embodiment has a smooth structure. The green inked rubber skin 20 is adhered to the tire surface 16 and the tire wall 14, and the green inked rubber skin 20 is printed with decorative patterns or texts.

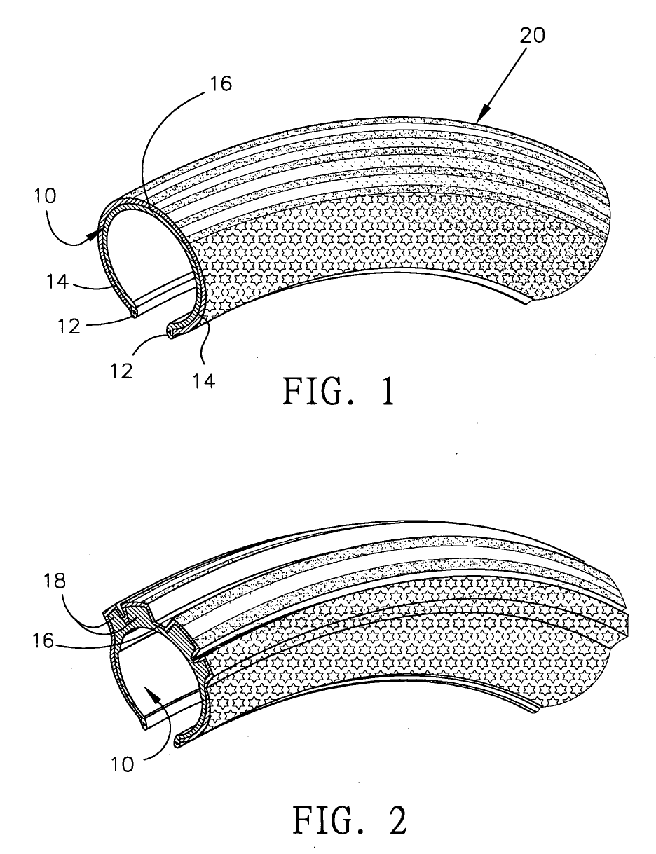

FIG. 2 is a partially exterior illustration showing a second embodiment of the invention. As shown in FIG. 2, the difference between the second embodiment and the first embodiment is that the surface of the green base tire 10 is formed with a plurality of projecting knobs 18 each located on the tire surface 16.

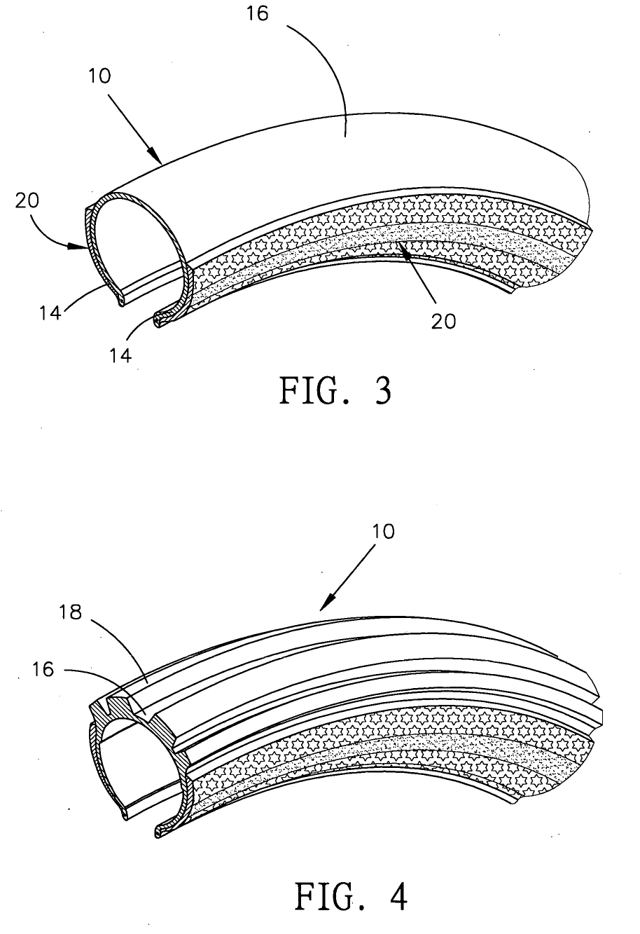

FIG. 3 is a partially exterior illustration showing a third embodiment of the invention. As shown in FIG. 3, the green inked rubber skin 20 is only adhered to the tire wall 14 of one green base tire 10, and the tire surface 16 of the green base tire 10 has the smooth structure in the third embodiment.

FIG. 4 shows a fourth embodiment of the invention. As shown in FIG. 4, the difference between the fourth and third embodiments is that the tire surface 16 of the green base tire 10 has a plurality of projecting knobs 18.

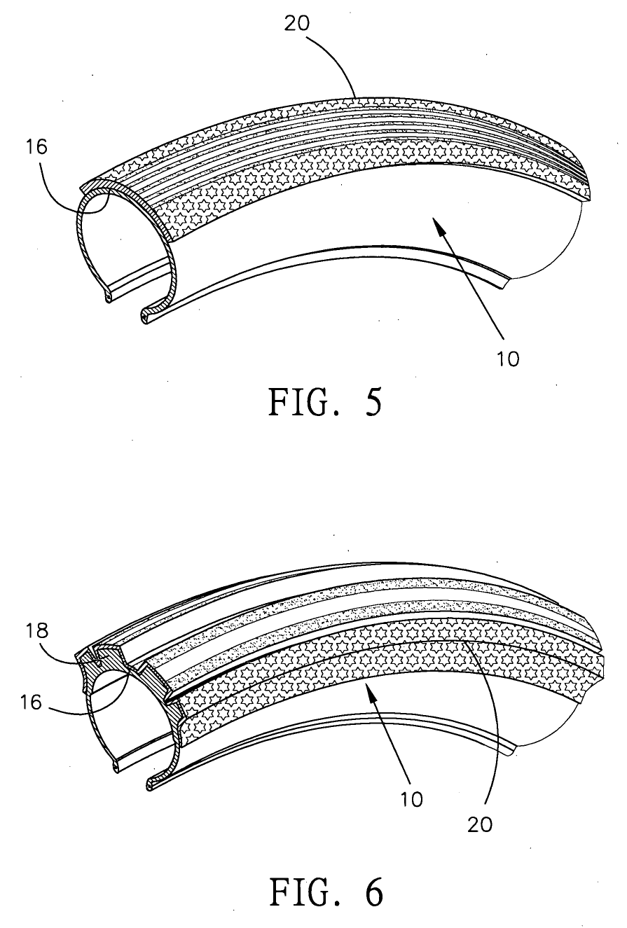

FIG. 5 is a partially exterior illustration showing a fifth embodiment of the invention. As shown in FIG. 5, the green inked rubber skin 20 is only adhered to the tire surface 16 of one green base tire 10. The tire surface 16 of the above-mentioned green base tire 10 has the smooth structure.

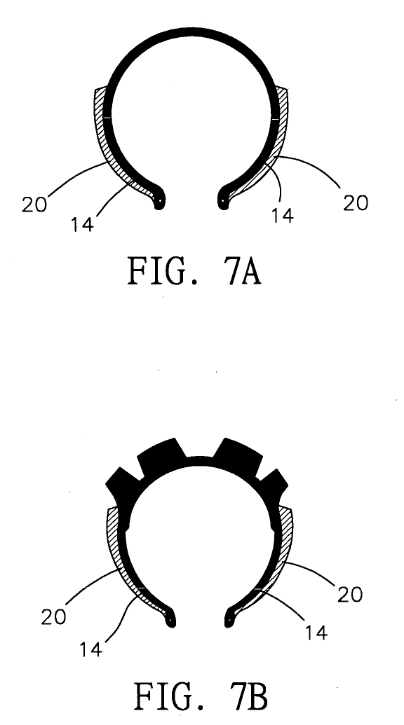

FIG. 6 is a partially exterior illustration showing a sixth embodiment of the invention. As shown in FIG. 6, the difference between the sixth and fifth embodiments is that the tire surface 16 of the green base tire 10 is formed with a plurality of projecting knobs 18, and the green inked rubber skin 20 is adhered to the tire surface 16 of the green base tire 10 and the knobs 18.

FIGS. 7A and 7B are schematic illustrations showing used states in this invention. As shown in FIGS. 7A and 7B, the green inked rubber skin 20 is located on the tire wall 14. When the tire is being normally used, the tire wall 14 cannot rub against the ground. So, the green inked rubber skin 20 on the tire wall 14 has the obvious marking function and cannot be damaged with the wear of the tire.

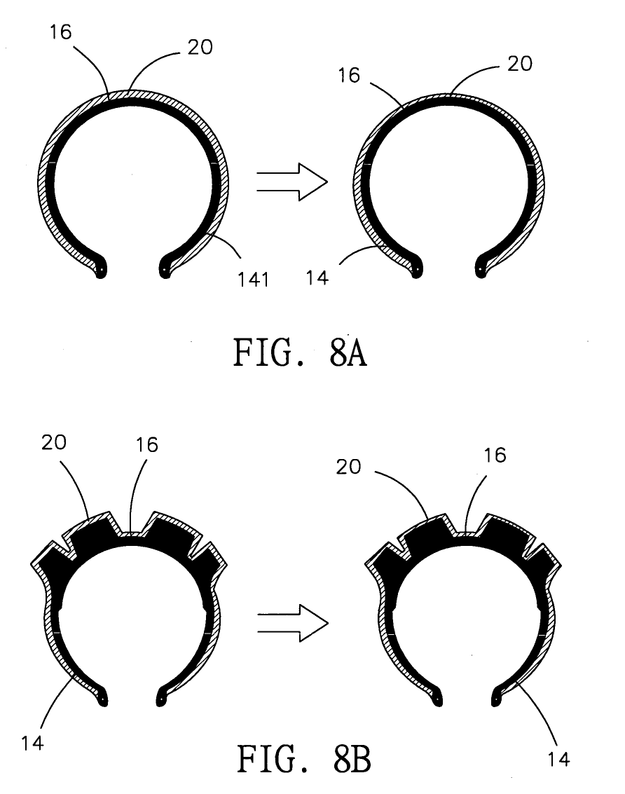

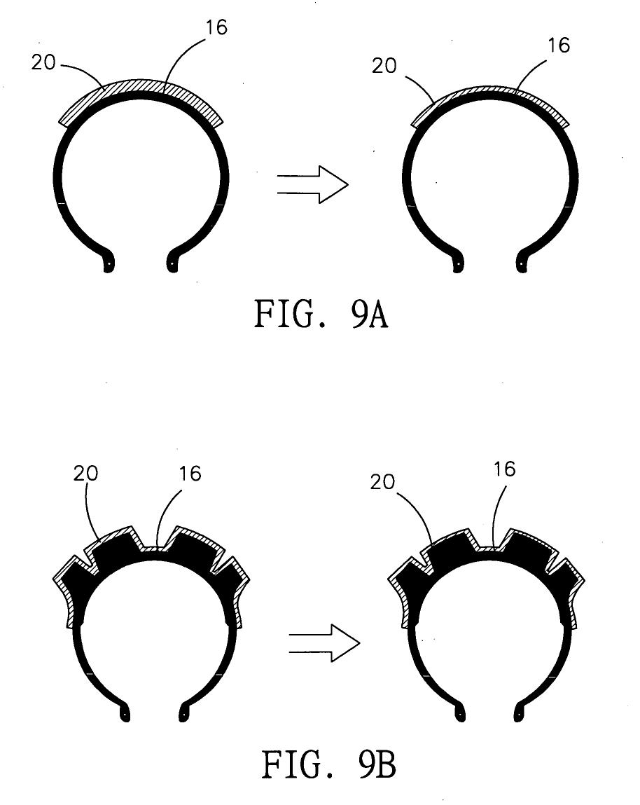

FIGS. 8A and 8B are schematic illustrations showing other used states in this invention. FIGS. 9A and 9B are schematic illustrations showing other used states in this invention. As shown in FIGS. 8A, 8B, 9A and 9B, the green inked rubber skin 20 is partially or fully located on the tire surface 16. Consequently, the green inked rubber skin 20 may be worn when the tire is used normally, but the worn skin can present another visual variation effect.

In addition, the structure in each of FIGS. 8A and 8B is located on the green inked rubber skin 20 of the tire wall 14 and cannot be damaged with the wear of the tire.

Consequently, the structure of the invention can make the tire have the obvious visual effect, and can enhance the visibility.

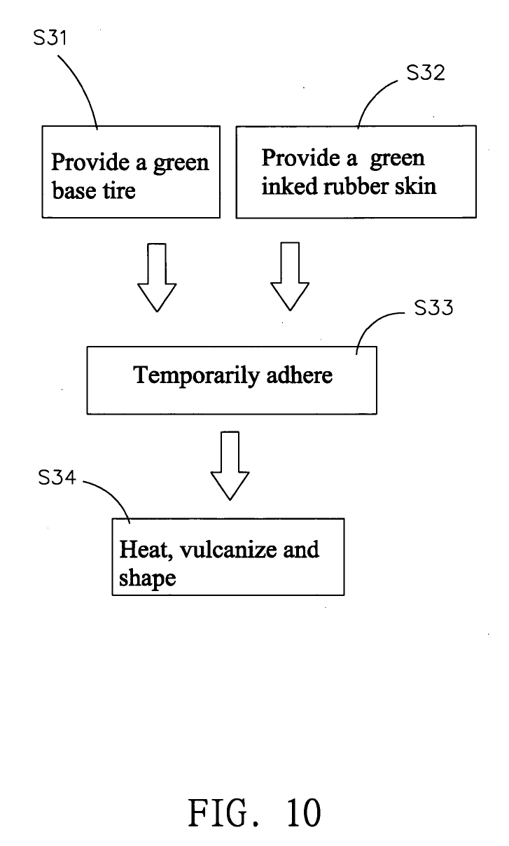

FIG. 10 is a block diagram showing steps of a manufacturing method according to the invention. Referring to FIG. 10, the method of the invention includes the following steps.

In step S31, a green base tire, especially an non-partial cured or vulcanized green base tire (or green tire), is provided.

In step S32, a green inked rubber skin printed with decorative or marked patterns or texts is provided.

In step S33, the green inked rubber skin is temporarily adhered to a predetermined position of the green base tire to form an assembly. For example, the green inked rubber skin is temporarily adhered to the tire wall or the tire surface, or simultaneously adhered to the tire surface and the tire wall. It is to be noted that the green inked rubber skin is adhered to the green base tire along the outer periphery of the green base tire so that the green inked rubber skin is formed with a ring structure.

In step S34, the assembly of the green base tire and the green inked rubber skin is placed into a vulcanizing machine for heating and vulcanizing the green base tire and the green inked rubber skin so that the green inked rubber skin is permanently combined with the green base tire, and the green base tire and the green inked rubber skin are finally shaped.

The invention adopts the green base tire and the green inked rubber skin as the materials before vulcanizing. Because the green base tire and the green inked rubber skin have the higher adhesive properties, the lower rigidity and the shapes that can easily be processed, and the green base tire and the green inked rubber skin may be easily combined together, the operations of adhering and placing the assembly into a mold become simpler.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A tire structure, comprising:
a green base tire having two opposite tire lips, two tire walls respectively extending from sides of the two tire lips, and a tire surface located between the two opposite tire walls; and
a green inked rubber skin combined with a surface of one of the tire walls of the green base tire to form a ring structure.

2. The tire structure according to claim 1, wherein the tire surface has a smooth structure.

3. The tire structure according to claim 1, wherein the tire surface has a plurality of projecting knobs.

4. The tire structure according to claim 1, wherein the green inked rubber skin has a text and/or a pattern.

5. A tire structure, comprising:
a green base tire having two opposite tire lips, two tire walls respectively extending from sides of the two tire lips, and a tire surface located between the two opposite tire walls; and
a green inked rubber skin combined with the tire surface of the green base tire to form a ring structure.

6. The tire structure according to claim 5, wherein the tire surface has a smooth structure.

7. The tire structure according to claim 5, wherein the tire surface has a plurality of projecting knobs.

8. The tire structure according to claim 5, wherein the green inked rubber skin extends to a surface of one of the tire walls.

9. The tire structure according to claim 5, wherein the green inked rubber skin extends to two surfaces of the tire walls.

10. A method of manufacturing a tire structure having an inked rubber skin, the method comprising the steps of:
(a) providing a green base tire;
(b) providing a green inked rubber skin;
(c) temporarily adhering the green inked rubber skin to a predetermined position of the green base tire to form an assembly; and
(d) placing the assembly of the green base tire and the green inked rubber skin into a vulcanizing machine for heating and vulcanizing the assembly for a period of time so that the green inked rubber skin is permanently combined with the green base tire.

11. The method according to claim 10, wherein the green base tire has a tire surface and two tire walls respectively located on two sides of the tire surface, and the green inked rubber skin is disposed on the tire surface and has a ring structure.

12. The method according to claim 10, wherein the green base tire has a tire surface and two tire walls respectively located on two sides of the tire surface, and the green inked rubber skin is disposed on a surface of one of the tire walls and has a ring structure.

13. The method according to claim 10, wherein the green base tire has a tire surface and two tire walls respectively located on two sides of the tire surface, and the green inked rubber skin is disposed on the tire surface and a surface of the tire wall and has a ring structure.

14. The method according to claim 11, wherein the tire surface has a smooth structure.

15. The method according to claim 11, wherein the tire surface has a plurality of projecting knobs.
